(19) United States
(12) Patent Application Publication
(10) Pub. No.: US 2005/0286275 A1
(43) Pub. Date: Dec. 29, 2005

(54) Power supply for portable printer

(75) Inventor: Han-chung Ryu, Seongnam-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/122,240

(22) Filed: May 5, 2005

(30) Foreign Application Priority Data
May 6, 2004 (KR) 10-2004-0031769

(51) Int. Cl. H02M 1/12

(52) U.S. Cl. 363/45

(57) ABSTRACT

A power supply for a portable printer, including an apparatus generating a main driving voltage and a driving voltage for driving a portable printer using the external alternating current voltage if an external alternating current voltage is applied, and which generates a main driving voltage and a driving voltage for driving the portable printer using an internal battery in the portable printer if no external alternating current voltage is applied. The power supply includes the reference DC voltage being lower than the first voltage. By lowering the reference DC voltage of the power supply, it is possible to substitute various circuit devices included in the power supply with low-cost components, thereby reducing a cost of the power supply.

### CROSS-REFERENCE TO RELATED APPLICATION

This application claims the benefit of Korean Patent Application No. 10-2004-0031769, filed on May 6, 2004, in the Korean Intellectual Property Office, the disclosure of which is incorporated herein in its entirety by reference.

### BACKGROUND OF THE INVENTION

1. Field of the Invention

Embodiments of the present invention relate to a power supply and method, and more particularly, to an apparatus and method for generating a main driving voltage and an auxiliary driving voltage for driving a portable printer using an external alternating current (AC) voltage if the external AC voltage is applied, and which generates a main driving voltage and an auxiliary driving voltage for driving the portable printer using an internal battery disposed in the portable printer if no external AC voltage is applied.

2. Description of the Related Art

FIG. 1 shows a structure of a conventional power supply for a printer. The power supply includes a main switch 100, a power supplying unit 110, and a main board driver 120.

Referring to FIG. 1, when the main switch 100 is on, an alternating current (AC) voltage supplied to the power supplying unit 110. The power supplying unit 110 converts the AC voltage received through the main switch 100 into various direct current (DC) voltages required for driving the printer, and outputs the converted result to the main board driver 120. Meanwhile, the main board driver 120 operates by a DC voltage applied from the power supplying unit 110, receives print data from a computer, and prints the print data on a print paper.

Meanwhile, Korean Patent Publication 1992-009018 sets forth another conventional technique including an adapter and high-speed charging device combination having a regulator for converting an AC input voltage into a predetermined DC voltage according to a load. Korean Patent Publication 1998-036816 further discloses a method for managing a voltage of a printer wherein the printer includes a power supplying unit for converting an AC voltage received through a main switch into DC voltages of +5V, −5V, +12V, and −12V, a data detector, and a backup battery.

However, the power supplies from these above-mentioned conventional techniques use a high reference DC voltage, e.g., a DC voltage applicable for driving a printer.

### SUMMARY OF THE INVENTION

According to an aspect of the present invention, a power supply for a portable printer provides an apparatus which generates a main driving voltage and an auxiliary driving voltage for driving a portable printer using an external alternating current (AC) voltage if the external AC voltage is applied, and which generates a main driving voltage and an auxiliary driving voltage for driving the portable printer using an internal battery included in the portable printer if no external AC voltage is applied.

To achieve the above and/or other aspects and advantages, embodiments of the present invention set forth a power supply system, including an AC/DC conversion unit generating a reference direct current (DC) voltage from an alternating current (AC) voltage external source, a step-up unit stepping up the reference DC voltage by a predetermined ratio and generating a first voltage, with the first voltage being a main driving voltage of a portable printer, and a step-down unit stepping down the reference DC voltage by a predetermined ratio and generating a second voltage, with the second voltage being an auxiliary driving voltage of the portable printer.

The system may further include a power storage unit which applies a voltage for generating the main driving voltage and/or the auxiliary driving voltage, to the step-up unit and the step-down unit, respectively. In addition, the generating of the main driving voltage and/or the auxiliary driving voltage based on the voltage from the power storage unit may occur upon no alternating current (AC) voltage being applied from the external source.

The AC/DC conversion unit may further include a charging unit for charging the power storage unit. In addition, the power storage unit may be included in the portable printer. The reference DC voltage may be lower than the first voltage.

To achieve the above and/or other aspects and advantages, embodiments of the present invention set forth a power supply system, including an AC/DC conversion unit generating a reference direct current (DC) voltage from an alternating current (AC) voltage external source, and a step-down unit stepping-down the reference DC voltage and generating an auxiliary driving voltage of the portable printer, wherein the power supply directly provides the reference DC voltage, output from the AC/DC conversion unit, to a corresponding electrical device, separate from the AC/DC conversion unit and the step-down unit, as a corresponding main driving voltage.

The system may further include a power storage unit generating the main driving voltage and the auxiliary driving voltage to the step-up unit and the step-down unit, respectively. The generating of the main driving voltage and/or the auxiliary driving voltage based on the voltage from the power storage unit may occur upon no alternating current (AC) voltage being applied from the external source.

The system may still further include a second step-down unit which receives the reference DC voltage from the AC/DC conversion unit, steps down the received reference DC voltage, and provides power to the power storage unit to charge the power storage unit.

To achieve the above and/or other aspects and advantages, embodiments of the present invention set forth a method of supplying power, including supplying a reference voltage from an AC/DC adapter to a step-down converter and generating an auxiliary driving voltage for an electrical device, supplying a battery voltage from a battery to a step-up unit to generate a main power voltage for the electrical device and supplying the battery with the reference voltage or the reference voltage modified by a step-down converter.

When external voltage is available from an external source to the AC/DC adapter, the reference voltage may be supplied to the step-up unit to generate the main power voltage. Further, when external voltage is available from an external source to the AC/DC adapter, the reference voltage may be supplied as the main power voltage.

Further, the electrical device may be a portable printer and the battery may be included within the portable printer, which is separate from the AC/DC adapter. The main power voltage may be 35V, and the auxiliary power voltage may be 5V.

Thus, embodiments of the present invention provide a power supply system which can be constructed using components with low withstanding voltages by lowering a reference voltage to be applied to the power supply.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a conventional power supply for a printer;

FIG. 2 illustrates a power supply for a portable printer, according to an embodiment of the present invention; and

FIG. 3 illustrates a power supply for a portable printer, according to another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

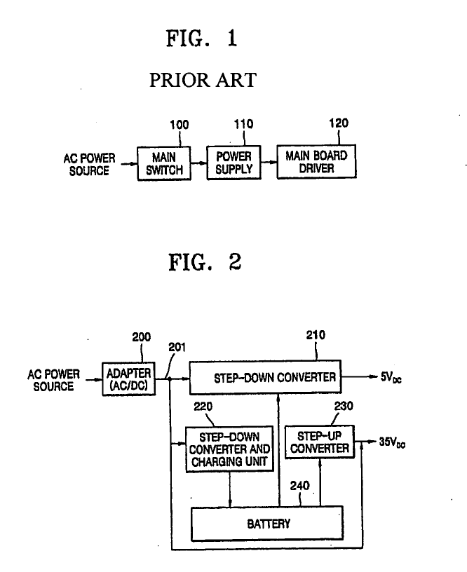

FIG. 2 illlustrates a power supply for a portable printer, according to an embodiment of the present invention. The power supply includes an adapter 200, a step-down converter 210, a step-down converter and charging unit 220, a step-up converter 230, and a battery 240.

Referring to FIG. 2, the adapter 200 smoothes an alternating current (AC) voltage received from an external source and generates a direct current (DC) voltage. The generated DC voltage can be used as a reference DC voltage 201 of the power supply. Here, the reference DC voltage 201 can be directly used as a main driving voltage, according to the present embodiment, while also being used for generating an auxiliary driving voltage. The portable printer to which the present invention is applied uses a voltage of +35 V as a main driving voltage and uses a voltage of +5 V as an auxiliary driving voltage.

According to this embodiment of the present invention, a reference DC voltage 201 output from the adapter 200 is +35V if the adapter 200 is connected to an external AC voltage, for example.

The step-down converter 210 receives the reference DC voltage 201 output from the adapter 200, steps down the reference DC voltage 201 by a predetermined ratio, and generates an ancillary driving voltage +5V. In detail, the step-down converter 210 steps down the reference DC voltage 201 and generates an ancillary driving voltage of +5V if an external AC voltage is applied. If no external AC voltage is applied, the step-down converter 210 steps down a voltage of a battery 240 (to be described later) and generates the ancillary driving voltage of +5V.

The step-down converter and charging unit 220 steps down the reference DC voltage 201 received from the adapter 200 if the external AC voltage is applied, and charges the battery 240 using an internal charging circuit.

The step-up converter 230 can receive a voltage of the battery 240 if no external AC voltage is applied, step up the received voltage by a predetermined ratio, and generate a main driving voltage of +35V, for example.

The battery 240 can be charged by a charging circuit disposed in the step-down converter and charging unit 220 if the external AC voltage is applied. If no external AC voltage is applied, the battery 240 can supply a voltage to the step-down converter 210 and the step-up converter 230 to generate the main driving voltage of +35V and the ancillary driving voltage of +5V

In summary, if the power supply is connected to an external AC voltage, an input voltage can be converted to a DC voltage by the adapter 200 and directly output as a main driving voltage of +35V, and simultaneously the input voltage can be stepped down to an ancillary driving voltage of +5V by the step-down converter 210 and output as the ancillary driving voltage of +5V. Also, the input voltage can be input to the step-down converter and charging unit 220 to charge the battery 240.

Meanwhile, if the power supply is not connected to an external AC voltage, the reference DC voltage can be supplied by the battery 240. A voltage output from the battery 214 can be stepped down by a predetermined ratio while being passed through the step-down converter 210, so that an auxiliary voltage of +5V is generated. Simultaneously, a main driving voltage of +35V can be generated by the step-up converter 220.

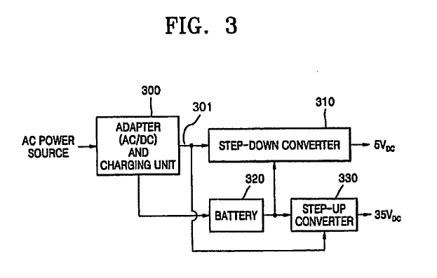

FIG. 3 illustrates a power supply for a portable printer, according to another embodiment of the present invention, wherein the power supply includes an adapter and charging unit 300, a step-down converter 310, a battery 320, and a step-up converter 330.

This power supply may include a charging unit with a charging function, differently from the power supply of FIG. 2, thereby potentially achieving an enhanced effect. Generally, the power supply can be constructed using components with a voltage margin higher, by about 50%, than a voltage to be applied to the power supply. Accordingly, by reducing the reference DC voltage, the power supply can perform the same function as the power supply of FIG. 2, using low-cost components with lower withstanding voltages. For example, a reference DC voltage of +35V may be used in the embodiment of FIG. 2, while a reference DC voltage of +24V may be used in the embodiment of FIG. 3.

Referring to FIG. 3, the adapter and charging unit 300 smoothes an AC voltage (external AC voltage) received from an external source and generates a reference DC voltage 301. Also, the charging unit disposed in the adapter and charging unit 300 can directly charge the battery. The reference DC voltage 301 can be input to the step-down converter 310 and used for generating the auxiliary driving voltage of +5V. Simultaneously, the reference DC voltage can be input to the step-up converter 330 and used for generating the main driving voltage of +35V.

The step-down converter 310 receives the reference DC voltage 301 from the adapter and charging unit 300 and can generate an auxiliary driving voltage of +5V if an external AC voltage is applied, and if no external AC voltage is applied, the step-down converter 310 can receive a voltage from the battery 320 and generate an auxiliary driving voltage of +5V, for example.

The battery 320 can be charged by the charging unit included in the adapter and charging unit 310 when an external AC voltage is applied, so that the battery 320 can supply its voltage to the step-down converter 310 and the step-up converter 330 to generate the auxiliary driving voltage of +5V and the main driving voltage of +35V, when no external AC voltage is applied.

The step-up converter 330 can receive the reference DC voltage 301 from the adapter and charging unit 300 and generate a main driving voltage of +35V if the external AC voltage is applied. If no external AC voltage is applied, the step-up converter 330 can generate a main driving voltage of +35V using a voltage received from the battery 320.

Compared to the power supply of FIG. 2, in the power supply of FIG. 3, the reference DC voltage output from the adapter and charging unit 300 can be +24V, which is lower than the main driving voltage of +35V and higher than the voltage of the battery 320, for example. By lowering the reference DC voltage of the power supply, it is possible to construct the power supply using components with low withstanding voltages, thereby reducing the manufacturing costs of the corresponding power supplies.

As described above, according to embodiments of the present invention, it is possible to supply a main driving voltage and an auxiliary driving voltage to a portable printer in correspondence with whether an external voltage is applied.

In particular, by lowering the reference DC voltage of the power supply, it is possible to substitute various circuit devices, included in the power supply, with low-cost components, thereby reducing a cost of the power supply.

Although a few embodiments of the present invention have been shown and described, it would be appreciated by those skilled in the art that changes may be made in these embodiments without departing from the principles and spirit of the invention, the scope of which is defined in the claims and their equivalents.

1. A power supply system, comprising:
an AC/DC conversion unit generating a reference direct current (DC) voltage from an alternating current (AC) voltage external source;
a step-up unit stepping up the reference DC voltage by a predetermined ratio and generating a first voltage, with the first voltage being a main driving voltage of a portable printer; and
a step-down unit stepping down the reference DC voltage by a predetermined ratio and generating a second voltage, with the second voltage being an auxiliary driving voltage of the portable printer.

2. The power supply system of claim 1, further comprising a power storage unit which applies a voltage for generating the main driving voltage and/or the auxiliary driving voltage, to the step-up unit and the step-down unit, respectively.

3. The power supply system of claim 2, wherein the generating of the main driving voltage and/or the auxiliary driving voltage based on the voltage from the power storage unit occurs upon no alternating current (AC) voltage being applied from the external source.

4. The power supply system of claim 1, wherein the AC/DC conversion unit further comprises a charging unit for charging the power storage unit.

5. The power supply system of claim 2, wherein the power storage unit is comprised in the portable printer.

6. The power supply system of claim 1, wherein the reference DC voltage is lower than the first voltage.

7. A power supply system, comprising: an AC/DC conversion unit generating a reference direct current (DC) voltage from an alternating current (AC) voltage external source; and
a step-down unit stepping-down the reference DC voltage and generating an auxiliary driving voltage of the portable printer,
wherein the power supply directly provides the reference DC voltage, output from the AC/DC conversion unit, to a corresponding electrical device, separate from the AC/DC conversion unit and the step-down unit, as a corresponding main driving voltage.

8. The power supply of claim 5, further comprising a power storage unit generating the main driving voltage and the auxiliary driving voltage to the step-up unit and the step-down unit, respectively.

9. The power supply system of claim 8, wherein the generating of the main driving voltage and/or the auxiliary driving voltage based on the voltage from the power storage unit occurs upon no alternating current (AC) voltage being applied from the external source.

10. The power supply of claim 6, further comprising a second step-down unit which receives the reference DC voltage from the AC/DC conversion unit, steps down the received reference DC voltage, and provides power to the power storage unit to charge the power storage unit.

11. A method of supplying power, comprising:
supplying a reference voltage from an AC/DC adapter to a step-down converter and generating an auxiliary driving voltage for an electrical device;
supplying a battery voltage from a battery to a step-up unit to generate a main power voltage for the electrical device and supplying the battery with the reference voltage or the reference voltage modified by a step-down converter.

12. The method of claim 11, wherein, when external voltage is available from an external source to the AC/DC adapter, the reference voltage is supplied to the step-up unit to generate the main power voltage.

13. The method of claim 11, wherein, when external voltage is available from an external source to the AC/DC adapter, the reference voltage is supplied as the main power voltage.

14. The method of claim 11, wherein the electrical device is a portable printer and the battery is comprised within the portable printer, which is separate from the AC/DC adapter.

15. The method of claim 11, wherein the main power voltage is 35V.

16. The method of claim 11, wherein the auxiliary power voltage is 5V.
